(19) United States
(12) Patent Application Publication
(10) Pub. No.: US 2010/0127428 A1
(43) Pub. Date: May 27, 2010

(54) Fabrication of carbon nanotubes reinforced semi-crystalline polymer composite bipolar plates for fuel cell

(75) Inventors: Chen-Chi M. Ma, Hsinchu (TW); Shu-Hang Liao, Hsinchu (TW); Chuan-Yu Yen, Hsinchu (TW); Cheng-Chih Weng, Hsinchu (TW); Ching-Hung Yang, Taichung (TW); Ming-Yu Yen, Hsinchu (TW); Min-Chien Hsiao, Hsinchu (TW); Shuo-Jen Lee, Taoyuan (TW); Yi-Hsiu Hsiao, Hsinchu (TW)

Correspondence Address: BACON & THOMAS, PLLC, 625 SLATERS LANE, FOURTH FLOOR, ALEXANDRIA, VA, 22314-1176, US

(73) Assignee: YUAN ZE UNIVERSITY, Taoyuan County (TW)

(21) Appl. No.: 12/458,649

(22) Filed: Jul. 20, 2009

(30) Foreign Application Priority Data
Nov. 27, 2008 (TW) 97146054

(51) Int. Cl. C08L 23/12; C08L 23/14; C08K 3/04; B29C 45/00; B29C 43/02

(52) U.S. Cl. 264/328.1; 524/582; 524/570; 524/496; 264/331.17; 977/750; 977/752; 977/742

(57) ABSTRACT

A composite bipolar plate for a polymer electrolyte membrane membrane fuel cell (PEMFC) is prepared as follows: a) melt compounding a polypropylene resin and graphite powder at 100-250° C. and 30-150 rpm to form a melt compounding material, the graphite powder content ranging from 50 wt % to 95 wt % based on the total weight of the graphite powder and the polypropylene resin, and the polypropylene resin being a homopolymer of propylene or a copolymer of propylene and ethylene, wherein 0.05-20 wt % carbon nanotubes, based on the weight of the polypropylene resin, are added during the melt compounding; and b) molding the melt compounding material from step a) to form a bipolar plate having a desired shaped at 100-250° C. and 500-4000 psi.

### FIELD OF THE INVENTION

The present invention relates to a process for preparing a fuel cell composite bipolar plate, particularly a process for preparing a carbon nanotubes reinforced polymer composite bipolar plate for a fuel cell by a melting compounding process with graphite powder, carbon nanotubes, and a thermoplastic resin.

### BACKGROUND OF THE INVENTION

U.S. Pat. No. 5,942,347 provides a bipolar separator plate suitable for use in a proton exchange membrane fuel cell produced by mixing at least one electronically conductive material, preferably a carbonaceous material, at least one resin, and at least one hydrophilic agent to form a substantially homogeneous mixture comprising the electronically conductive material in an amount in a range of about 50% to 95% by weight of the mixture, at least one resin in an amount of at least about 5% by weight of the mixture, and said at least one hydrophilic agent. The mixture is then molded into a desired shape at a temperature in a range of about 250° F. to 800° F., which temperature is a function of the resin used, and a pressure in a range of about 500 psi to 4,000 psi, resulting in formation of the bipolar plate. The resin used in this U.S. patent can be selected from the group consisting of thermosetting resins, thermoplastic resins, and mixtures thereof, preferably a thermosetting resin. Suitable thermoplastic resins are polyvinylidene fluorides, polycarbonates, nylons, polytetrafluoroethylenes, polyurethenes, polyesters, polypropylenes, and HDPE. However, no example in this U.S. patent shows polypropylene being used.

U.S. Pat. No. 4,214,969 discloses a fuel cell bipolar plate made of a polymer composite containing 74 wt % of graphite powder in polyvinylidene fluoride (PVDF) resin (Kynar®). This prior art bipolar plate has a flexural strength of 37.2 MPa and a electrical conductivity of 119 S/cm.

U.S. Pat. No. 7,056,452 discloses an electrically conductive composite as a fuel cell polar plate comprising a polyvinylidene fluoride (PVDF) polymer or copolymer and carbon nanotubes. Preferably, carbon nanotubes may be present in the range of about 0.5-20% by weight of the composite. The bipolar plate will has a decreasing volume resisitivity when the content of carbon nanotubes increases, e.g. lower than 1 ohm-cm when the content of carbon nanotubes is 5 wt %, and about 0.08 ohm-cm as the content of carbon nanotubes is 13 wt %.

U.S. Pat. No. 6,746,627 discloses that composites containing polyvinylidene fluoride (PVDF) polymer or copolymer and carbon nanotubes have extraordinary electrical conductivity. PVDF or PVDF/hexafluoropropylene (HFP) copolymer composites with 13% or less by weight carbon nanotubes have an improved bulk resistivity. The PVDF/HFP copolymer has lower crystallinity than PVDF polymer. The bulk resistivity of the PVDF/HFP composite drops below 1 ohm-cm at 3.1 % nanotube loading and the lowest reported bulk resistivity observed was 0.072 ohm-cm at 13.3% nanotube loading, which is within the range of bulk resistivity for a pure carbon nanotube mat. However, no improvement in bulk resistivity was observed for PVDF/HFP composites with more than 13.3% nanotube loading. PVDF/HFP composites with nanotube loadings up to approximately 3% appeared to have lower bulk resistivities than those of PVDF composites with the same nanotube loadings. Thus, at low nanotube loading, the conductivity of a PVDF composite may be improved by using a PVDF/HFP copolymer, or a lower grade PVDF with less crystallinity, instead of a pure PVDF polymer.

US patent publication No. 2004/0191608 discloses a method of making a current collector plate for use in a proton exchange membrane fuel cell, the method comprising the steps of: (a) molding by injection or compression molding a composition comprising from about 10 to about 50% by weight of a plastic, from about 10 to about 70% by weight of a graphite fibre filler, and from 0 to about 80% by weight of a graphite powder filler to form the current collector plate having two surface layers; (b) measuring the thickness of the current collector plate; and (c) removing the surface layers to reduce the thickness of the current collector plate by no more than about 10 micrometers. It was found that removing a much smaller layer from the surfaces of the molded plates may significantly increase the conductivity of molded polymeric current collector plates.

To this date, the industry is still continuously looking for a small fuel cell bipolar plate having a high electric conductivity, excellent mechanical properties, a high thermal stability and a high size stability, which can be commercialized with a lower cost.

### SUMMARY OF THE INVENTION

One primary objective of the present invention is to provide a small size fuel cell bipolar plate having a high electrical conductivity, and excellent mechanical properties.

Another objective of the present invention is to provide a process for preparing a small size fuel cell bipolar plate having a high electrical conductivity, and excellent mechanical properties.

The process for preparing a composite bipolar plate for a polymer electrolyte membrane fuel cell (PEMFC) according to one of the preferred embodiments the present invention uses a melt compounding material comprising a polypropylene resin, a conductive carbon, and carbon nanotubes. The polypropylene resin used is a semi-crystalline polypropylene resin, and a suitable example is a homopolymer of propylene or a copolymer of propylene and ethylene having a crystallinity lower than 50%, preferably 30-50%. The production cost of the bipolar plate according to the process of the present invention is reduced with a polypropylene resin which is cheap in price, by selecting a polypropylene resin having a suitable melt flow index and mechanical properties. Further, a melt compounding material with graphite powder and carbon nanotubes uniformly dispersed in the polypropylene resin is formed according to the process of the present invention, which in turn renders the bipolar plate polyether prepared by the present invention has a high electrical conductivity, and excellent mechanical properties.

In order to accomplish the aforesaid objectives a process for preparing a composite bipolar plate for a polymer electrolyte membrane fuel cell (PEMFC) according to the present invention comprises:

a) melt compounding a polypropylene resin and graphite powder to form a melt compounding material, the graphite powder content ranging from 50 wt % to 95 wt % based on the total weight of the graphite powder and the polypropylene resin, wherein the polypropylene resin is a homopolymer of propylene or a random copolymer of 75-99 wt % propylene and 1-25 wt % of ethylene, butylenes or hexalene, and wherein 0.05-20 wt % carbon nanotubes, based on the weight of the polypropylene resin, are added during the melt compounding; and

b) molding the melt compounding material from step a) to form a bipolar plate having a desired shaped at 100-250° C. and 500-4000 psi.

Preferably, the process of the present invention further comprises pulverizing the melt compounding material from step a) to form a melt compounding powder, and wherein step b) comprises placing the melt compounding powder in a mold.

Preferably, the polypropylene resin has a crystallinity of 15-70%. More preferably, the polypropylene resin has a crystallinity of 30-50%.

Preferably, the polypropylene resin has a melt flow index of 10-50 g/10 min.

Preferably, the polypropylene resin is the homopolymer of propylene.

Preferably, the polypropylene resin is the random copolymer. More preferably, the polypropylene resin is the random copolymer of propylene and ethylene.

Preferably, said carbon nanotubes are modified or pristine carbon nanohorns, modified or pristine carbon nanocapsules, modified or pristine single-walled carbon nanotubes, modified or pristine double-walled carbon nanotubes, or modified or pristine multi-walled carbon nanotubes.

More preferably, said carbon nanotubes are modified or pristine single-walled carbon nanotubes, modified or pristine double-walled carbon nanotubes, or modified or pristine multi-walled carbon nanotubes, and said carbon nanotubes have a diameter of 10-50 nm, a length of 1-25 μm, a specific surface area of 150-250 m²g⁻¹, and an aspect ratio of 20-2500 m²/g.

Preferably, said melt compounding in step a) is carried out by using a high shear blender or ball mill. More preferably, said melt compounding in step a) is carried out by using a high shear blender.

Preferably, said molding in step b) is a compression molding or injection molding.

Preferably, the polypropylene resin contains 0.1-3% of UV absorbent, based on the weight of the polypropylene resin.

Preferably, the polypropylene resin contains 0.1-3% of anti-oxidation agent, based on the weight of the polypropylene resin.

Preferably, particles of said graphite powder have a size of 10-80 mesh. More preferably, less than 10 wt % of the particles of the graphite powder are larger than 40 mesh, and the remaining particles of the graphite powder have a size of 40-80 mesh.

In one of the preferred embodiments of the present invention, a high performance polypropylene/graphite composite bipolar plate was prepared from a homopolymer of propylene having a crystallinity of 45% carbon nanotubes dispersed therein, which has a volume conductivity greater than 200 S/cm, a flexural strength as high as about 33 MPa and an IZOD impact strength of 61 J/m. The volume conductivity greater than 200 S/cm is significantly higher than the technical criteria index of 100 S/cm of DOE of US.

In another one of the preferred embodiments of the present invention, a high performance polypropylene/graphite composite bipolar plate was prepared from a copolymer of propylene and ethylene having a crystallinity of 41% carbon nanotubes dispersed therein, which has a volume conductivity greater than 200 S/cm, a flexural strength as high as about 31 MPa and an IZOD impact strength of 67 J/m. The volume conductivity greater than 200 S/cm is significantly higher than the technical criteria index of 100 S/cm of DOE of US.

In still another one of the preferred embodiments of the present invention, a high performance polypropylene/graphite composite bipolar plate was prepared from a copolymer of propylene and ethylene having a crystallinity of 35% carbon nanotubes dispersed therein, which has a volume conductivity greater than 200 S/cm, a flexural strength as high as about 29 MPa and an IZOD impact strength of 81 J/m. The volume conductivity greater than 200 S/cm is significantly higher than the technical criteria index of 100 S/cm of DOE of US.

### DETAILED DESCRIPTION OF THE INVENTION

The present invention provides a composite bipolar plate is produced by a melt compounding process using a polypropylene resin as a resin part of the composite. The polypropylene resin is a semi-crystalline resin comprising a homopolymer of propylene or a copolymer of propylene as a major portion and other ethylenically unsaturated monomer. The composite further comprises graphite power dispersed in the polypropylene resin to enhance the electrically conductivity of the composite and carbon nanotubes blended therein as a reinforced material. The carbon nanotubes can be modified before use or pristine carbon nanotubes can be directly used. The melt compounding process can be carried out by feeding the polypropylene resin, graphite powder and carbon nanotubes to a brabender and operating the brabender at 100-250° C. and 30-150 rpm.

The polypropylene resin, graphite powder, and carbon nanotubes among other materials used in the following examples are described as follows:
Polypropylene resins: Codes PP4204, PP3354 and PP1120 supplied from the Yung Chia Chemical Ind., Co., Ltd., Taiwan. PP4204 and PP3354 are ethylene-propylene copolymers having melt flow indices (MFI) of 19 g/10 min and 35 g/10 min, respectively, and ethylene contents of 14 wt % and 5-7 wt %, respectively. PP1120 is a propylene homopolymer having a MFI of 15 g/10 min.
Graphite powder provide by Great Carbon Co. Ltd., Taiwan.
Multi-Walled CNT (abbreviated as MWCNT) produced by The CNT Company, Inchon, Korea, and sold under a code of C_{tube 100}. This type of CNT was prepared by a CVD process. The CNTs had a purity of 95%, a diameter of 10-50 nm, a length of 1-25 μm, and a specific surface area of 150-250 m2g⁻¹.

### EXAMPLE 1

The graphite powder used in this example consisted of not more than 10% of particles larger than 40 mesh (420 μm in diameter), about 40% of particles between 40 mesh and 60 mesh (420-250 μm in diameter), and about 50% of particles between 60 mesh and 80 mesh (250-177 μm in diameter).

### Preparation of Melt Compounding Material and Specimen

1. 10 g of propylene homopolymer (PP1120), 40 g of the above-mentioned graphite powder and 0.8 g of pristine carbon nanotubes (C_{tube 100}) were introduced into a brabender, where they were melt compounded at 180° C. and 50 rpm for 10 minutes. The melt compound material was removed from the brabender and cooled at room temperature.
2. The melt compound material was divided into several lumps, which were then pulverized in a mill for two minutes and half to form powders.
3. A slab mold was fastened to the upper and lower platforms of a hot press. The pre-heating temperature of the mold was set to 180° C. After the temperature had reached the set point, the powder was disposed at the center of the mold and pressed with a pressure of 1500 psi to form a specimen. After 30 minutes, the heater was turned off and the specimen was cooled in the mold to 80° C., which was then removed from the mold.

### EXAMPLES 2 and 3

The steps in Example 1 were repeated to prepare powders of molding material and specimens, except that the propylene homopolymer (PP1120) was replaced by the ethylene-propylene copolymers PP3354 and PP4204) as listed in the following Table 1.

TABLE 1

| | | Content of | Amount of |
|---|---|---|---|
| | | ethylene, | addition, g |
| Example | Polypropylene resin | wt %** | (wt %*) |
| 2 | Ethylene-propylene | 5-7% | 0.8 (1.6%) |
| | copolymer | | |
| | PP3354 | | |
| 3 | Ethylene-propylene | 14% | 0.8 (1.6%) |
| | copolymer | | |
| | PP4204 | | |

*%, based on the weight of the polypropylene resin and graphite powder.
**%, based on the weight of the comonomers

### Crystalline Properties:

### Test Method:

Thermal analysis measurements were performed utilizing a differential scanning calorimeter (PYRIS Diamond DSC, Perkin Elmer Co., USA). 5 mg sample was maintained at 35° C. in nitrogen atmosphere for 3 minutes, and heated from 35° C. to 200° C. at a rate of 5° C./min, so that it became molten. Subsequently, the sample was cooled to 35° C. at a rate of 5° C./min, thereby the sample crystallized while releasing heat. The degree of crystallinity (Xc) of the sample was evaluated based on the following equation 1:

$$Xc ( \% ) = \frac{Δ Hc}{Δ {Hc}^{0} \times {W}_{polymer}} \qquad ( formula 1 )$$

wherein ΔHc is the specific melting heat of the, ΔHc⁰ is the theoretical specific melting heat of 100% crystallinity of propylene homopolymer (209 J/g), and W_{polymer} is the weight fraction of polypropylene in the sample.

### Results

Table 2 shows the degree of crystallinity measured for the polymer composite bipolar plates prepared above, wherein the polypropylene resins are different but the graphite powder content and the carbon nanotube content are fixed at 80 wt % and 1.6 wt %, respectively. It is obvious that Xc decreases gradually with the increasing of ethylene content, where Xc related to ethylene contents are 34.9% (14 wt % of ethylene), 41.1% (5-7 wt % of ethylene) and 45.1% (0 wt % of ethylene), respectively, as shown in Table 2. These results indicate that the more heterogeneous phase resulted from ethylene in polypropylene may hinder the folding chain of polypropylene molecular chain during crystal formation, and thus causes further decrease of crystalline regions of the polymer composite bipolar plates.

TABLE 2

| | Degree of |
|---|---|
| | crystallinity (%) |
| Example 1 | 45.1 |
| Example 2 | 41.1 |
| Example 3 | 34.9 |

### Electrical Properties:

### Test Method:

A four-point probe resistivity meter was used by applying a voltage and an electric current on the surface of a specimen at one end, measuring at the other end the voltage and the electric current passed through the specimen, and using the Ohm's law to obtain the volume resistivity (ρ) of the specimen according to the formula,

$$ρ = \frac{V}{I} * W * CF , \qquad ( formula 2 )$$

wherein V is the voltage passed through the specimen, I is the electric current passed through the specimen, a ratio thereof is the surface resistivity, W is the thickness of the specimen, and CF is the correction factor. The thermally compressed specimens from the examples were about 100 mm×100 mm with a thickness of 4 mm. The correction factor (CF) for the specimens was 4.5. Formula 2 was used to obtain the volume resistivity (ρ) and an inversion of the volume resistivity is the electric conductivity of a specimen.

### Results:

Table 3 shows the resistivity measured for the polymer composite bipolar plates prepared above, wherein the polypropylene resins are different but the graphite powder content and the carbon nanotube content are fixed at 80 wt % and 1.6 wt %, respectively. The measured resistivities for the polymer composite bipolar plates prepared in Examples 1, 2 and 3 respectively are 2.36 mΩ, 1.88 mΩ, and 1.15 mΩ. Table 4 shows the electrical conductivity measured for the polymer composite bipolar plates prepared above. The measured conductivities for the polymer composite bipolar plates prepared in Examples 1, 2, and 3 respectively are 234 S/cm, 294 S/cm and 481 S/cm, which are above the DOE target value of 100 S/cm. The poor dispersion of MWCNTs in the polymer matrix, which typically appear as clusters in the polymer matrix, is recognized as their strong intertublar Van deer Waals force. Incorporation of graphite powder with a small amount of MWCNTs is effective to develop higher bulk electrical conductivity of the polymer composite bipolar plates due to 3D conductive networks. As shown in Tables 3 and 4, Example 1 has the highest resistivity (lowest electrical conductivity), Example 2 is the next, and Example 3 has the lowest resistivity (highest electrical conductivity), corresponding to the degree of crystallinity of the polypropylene resin used. The lower degree of crystallinity of the polypropylene resin means it has more non-crystalline regions, which promote the uniform dispersions of MWCNTs and graphite powder with less aggregation, leading to an increase of effective electrical conducting paths formed between MWCNTs and graphite powder, so that the polymer composite bipolar plate exhibits a lower resistivity (higher electrical conductivity).

TABLE 3

| | Resistivity (mΩ) |
|---|---|
| Example 1 | 2.36 |
| Example 2 | 1.88 |
| Example 3 | 1.15 |

TABLE 4

| | Conductivity (S/cm) |
|---|---|
| Example 1 | 234 |
| Example 2 | 294 |
| Example 3 | 481 |

### Mechanical Property: Test for Flexural Strength

### Method of Test : ASTM D790

### Results:

Table 5 shows the test results of flexural strength for polymer composite bipolar plates prepared above, wherein the polypropylene resins are different but the graphite powder content and the carbon nanotube content are fixed at 80 wt % and 1.6 wt %, respectively. The measured flexural strength for the polymer composite bipolar plates prepared in Examples 1, 2, and 3 respectively are 33.62±1.25 MPa, 31.70±1.32 MPa, and 29.49±1.13 MPa. In addition the flexural strength for the polymer composite bipolar plates prepared by repeating the procedures in Examples 1, 2, and 3, except that MWCNTs were not added during the melt compounding, are also listed in Table 5. The results indicate that addition of MWCNTs in the polypropylene resin having a lower degree of crystallinity will better enhance the flexural strength in comparison with the addition of MWCNTs in the polypropylene resin having a higher degree of crystallinity.

TABLE 5

| | (A) | (B) | |
|---|---|---|---|
| | Flexural strength | Flexural strength | |
| | (MPa) | (MPa) | ((B) − (A))/(A) × |
| | without MWCNTs* | with MWCNTs | 100% |
| Example 1 | 25.92 ± 1.03 | 33.62 ± 1.25 | 29.7% |
| Example 2 | 23.67 ± 0.95 | 31.70 ± 1.32 | 33.9% |
| Example 3 | 21.44 ± 0.86 | 29.49 ± 1.13 | 37.5% |

*flexural strength for the polymer composite bipolar plates prepared by repeating the procedures in Examples 1, 2, and 3, except that MWCNTs were not added during the melt compounding.

### Mechanical Property: Test for Impact Strength

### Method of Test: ASTM D256

### Results:

Table 6 shows the test results of notched Izod impact strength for polymer composite bipolar plates prepared above, wherein the polypropylene resins are different but the graphite powder content and the carbon nanotube content are fixed at 80 wt % and 1.6 wt %, respectively. The measured notched Izod impact strength for the polymer composite bipolar plates prepared in Examples 1, 2, and 3 respectively are 61.12 J/m, 67.44 J/m, and 81.44. In addition the Izod impact strength for the polymer composite bipolar plates prepared by repeating the procedures in Examples 1, 2, and 3, except that MWCNTs were not added during the melt compounding, are also listed in Table 6. The results shown in Table 6 have the same trend as shown in Table 5, i.e. that addition of MWCNTs in the polypropylene resin having a lower degree of crystallinity will better enhance the Izod impact strength in comparison with the addition of MWCNTs in the polypropylene resin having a higher degree of crystallinity.

TABLE 6

| | (A) | (B) | |
|---|---|---|---|
| | Impact | Impact | |
| | strength (J/m) | strength (J/m) | ((B) − (A))/(A) × |
| | without MWCNTs* | with MWCNTs | 100% |
| Example 1 | 54.23 | 61.12 | 12.7% |
| Example 2 | 58.61 | 67.44 | 15.0% |
| Example 3 | 68.27 | 81.44 | 19.3% |

*Izod impact strength for the polymer composite bipolar plates prepared by repeating the procedures in Examples 1, 2, and 3, except that MWCNTs were not added during the melt compounding.

### Coefficient of Thermal Expansion

### Method of Test: ASTM D-696

### Results:

PEMFC is operated at a temperature from room temperature to about 80° C. The bipolar plate has many delicate passages and MEA is clamped between two bipolar plates, so that the bipolar plate must have a good dimension stability during the temperature ramp from room temperature to about 80° C. in order to maintain the system function. The dimension stability of the bipolar plate can be determined by measuring coefficient of thermal expansion thereof.

Table 7 lists coefficients of thermal expansion measured for the bipolar plates prepared above, wherein the polypropylene resins are different but the graphite powder content and the carbon nanotube content are fixed at 80 wt % and 1.6 wt %, respectively. The measured coefficients of thermal expansion for the polymer composite bipolar plates prepared in Examples 1, 2, and 3 respectively are 50.03 μm/m° C., 30.16 μm/m° C., and 25.81 μm/m° C. In addition the coefficients of thermal expansion for the polymer composite bipolar plates prepared by repeating the procedures in Examples 1, 2, and 3, except that MWCNTs were not added during the melt compounding, are also listed in Table 7. The results indicate that addition of MWCNTs in the polypropylene resin having a lower degree of crystallinity will better reduce the coefficient of thermal expansion in comparison with the addition of MWCNTs in the polypropylene resin having a higher degree of crystallinity.

TABLE 7

| | Coefficient of Thermal | Coefficient of Thermal |
|---|---|---|
| | Expansion without | Expansion with MWCNTs |
| | MWCNTs* (μm/m ° C.) | (μm/m ° C.) |
| Example A2 | 50.91 | 50.03 |
| Example B1 | 37.28 | 30.16 |
| Example B2 | 32.94 | 25.81 |

*Coefficients of thermal expansion for the polymer composite bipolar plates prepared by repeating the procedures in Examples 1, 2, and 3, except that MWCNTs were not added during the melt compounding.

### Gas Tightness Test

### Method of Test:

Two chambers are separated by the bipolar plate prepared above, one of which is maintained at vacuum pressure, and another of which is maintained at a pressure of 5 bar. The gas tightness of the polymer composite bipolar plate is determined by observing the pressure changes in the two chambers.

### Results:

The bipolar plates in a PEMFC are gas flow fields, on which many delicate passages are formed. Hydrogen and air separately flow in the passages of two bipolar plates and diffuse through a gas diffusion membrane to MEA. The bipolar plate thus is required to have a good gas tightness to assure a high efficiency of the PEMFC.

Table 8 lists the gas tightness test results for the bipolar plates prepared above, wherein the polypropylene resins are different but the graphite powder content and the carbon nanotube content are fixed at 80 wt % and 1.6 wt %, respectively. It can be seen from Table 8 that the polymer composite bipolar plates prepared in Examples 1, 2 and 3 all show good gas tightness.

TABLE 8

| | Gas tightness |
|---|---|
| Example 1 | No leaking |
| Example 2 | No leaking |
| Example 3 | No leaking |

In view of the above test results, the small size polymer composite bipolar plate prepared in accordance with the method of the present invention is therefore readily to be applied commercially in view of its comprehensive performance. In the following Table 9, the conductivity and flexural strength of the polymer composite bipolar plates prepared in the prior art and Example 3 of the present invention are listed. It can be seen from Table 9 that the polymer composite bipolar plate prepared in Example 3 of the present invention has better performance in conductivity than the PVDF/carbon nanotube composite bipolar plates disclosed in U.S. Pat. No. 6,746,627 and U.S. Pat. No. 6,572,997; and that the polymer composite bipolar plate prepared in Example 3 of the present invention has better performance in conductivity and flexural strength than the commercial graphite/thermoplastic composite bipolar plate disclosed in U.S. Pat. No. 6,248,467 (BMC, Inc.).

TABLE 9

| | | Flexural | |
|---|---|---|---|
| | Conductivity | strength | |
| Composition | (S/cm) | (MPa) | Source |
| commercial | 105 | 20.7 | U.S. Pat. No. |
| graphite/thermoplastic | | | 6,248,467 |
| PVDF/20% CNTs | 23.7 | 36.7 | U.S. Pat. No. |
| | | | 6,746,627 |
| PVDF/40% CNTs | 20 | 42.7 | U.S. Pat. No. |
| | | | 6,572,997 |
| PP/1.6% MWCNTs | 481 | 29.5 | Example 3 of |
| | | | this invention |

1. A process for preparing a fuel cell composite bipolar plate, which comprises the following steps:
a) melt compounding a polypropylene resin and graphite powder to form a melt compounding material, the graphite powder content ranging from 50 wt % to 95 wt % based on the total weight of the graphite powder and the polypropylene resin, wherein the polypropylene resin is a homopolymer of propylene or a random copolymer of 75-99 wt % propylene and 1-25 wt % of ethylene, butylenes or hexalene, and wherein 0.05-20 wt % carbon nanotubes, based on the weight of the polypropylene resin, are added during the melt compounding; and
b) molding the melt compounding material from step a) to form a bipolar plate having a desired shaped at 100-250° C. and 500-4000 psi.

2. The process as claimed in claim 1 further comprising pulverizing the melt compounding material from step a) to form a melt compounding powder, and wherein step b) comprises placing the melt compounding powder in a mold.

3. The process as claimed in claim 1, wherein the polypropylene resin has a crystallinity of 15-70%.

4. The process as claimed in claim 3, wherein the polypropylene resin has a crystallinity of 30-50%.

5. The process as claimed in claim 1, wherein the polypropylene resin has a melt flow index of 10-50 g/10 min.

6. The process as claimed in claim 1, wherein the polypropylene resin is the homopolymer of propylene.

7. The process as claimed in claim 1, wherein the polypropylene resin is the random copolymer.

8. The process as claimed in claim 7, wherein the polypropylene resin is the random copolymer of propylene and ethylene.

9. The process as claimed in claim 1, wherein said carbon nanotubes are modified or pristine carbon nanohorns, modified or pristine carbon nanocapsules, modified or pristine single-walled carbon nanotubes, modified or pristine double-walled carbon nanotubes, or modified or pristine multi-walled carbon nanotubes.

10. The process as claimed in claim 9, wherein said carbon nanotubes are modified or pristine single-walled carbon nanotubes, modified or pristine double-walled carbon nanotubes, or modified or pristine multi-walled carbon nanotubes, and said carbon nanotubes have a diameter of 10-50 nm, a length of 1-25 μm, a specific surface area of 150-250 m²g⁻¹, and an aspect ratio of 20-2500 m²/g.

11. The process as claimed in claim 1, wherein said melt compounding in step a) is carried out by using a high shear blender or ball mill.

12. The process as claimed in claim 11, wherein said melt compounding in step a) is carried out by using a high shear blender.

13. The process as claimed in claim 1, wherein said molding in step b) is a compression molding or injection molding.
